(19) United States
(12) Patent Application Publication
(10) Pub. No.: US 2011/0021711 A1
(43) Pub. Date: Jan. 27, 2011

(54) CROSSLINKED POLYMER PARTICLES

(75) Inventors: John S. Parent, Kingston (CA); Saurav S. Sengupta, Somerset, NJ (US); Bharat I. Chaudhary, Princeton, NJ (US); Jeffrey M. Cogen, Flemington, NJ (US)

Correspondence Address: The Dow Chemical Company, P.O. BOX 1967, 2040 Dow Center, Midland, MI, 48641, US

(73) Assignees: Queen's University at Kingston, Kingston, ON (CA); Dow Global Technologies Inc., Midland, MI (US)

(21) Appl. No.: 12/933,983

(22) PCT Filed: Mar. 31, 2009
(86) PCT No.: PCT/US09/38871

§ 371 Date: Sep. 22, 2010

Related U.S. Application Data
(60) Provisional application No. 61/040,927, filed on Mar. 31, 2008.

(51) Int. Cl. C08F 255/00; C08G 79/04

(52) U.S. Cl. 525/302; 528/392

(57) ABSTRACT

The present invention is crosslinked polymer particles, prepared from a free-radical activated reaction of an unsaturated coagent and low molecular weight hydrocarbons or certain polymers. This invention allows particles to be made from mixtures of coagents and saturated compounds. The invention is also a process for preparing crosslinked polymer particles.

The present invention relates to the preparation of crosslinked organic particles or fused microporous solids. In particular, the present invention relates to radical-mediated preparation of crosslinked organic particles or fused microporous solids.

Conventional polymerization methods of preparing particles (emulsion, mini-emulsion, suspension, precipitation, and dispersion polymerizations) build particles from unsaturated monomers such as acrylates and styrenics. Conventionally, substrates such as cyclooctane cannot engage in polymerization or yield crosslinked polymer particles.

There is a need to make particles or fused microporous solids from mixtures of saturated substrates and tailor their composition. There is also a need to make functional particles or fused microporous solids that carry a desirable functional group. Furthermore, there is a need to seed core-shell particle morphologies with pre-existing particles.

Under the present invention, a free-radical activated reaction of an unsaturated coagent and low molecular weight hydrocarbons or certain polymers yields useful, stable particles or fused microporous solids. In particular, this invention allows particles or fused microporous solids to be made from mixtures of coagents and saturated compounds.

Under the present invention and in theory, any C—H donor that can graft to C═C is amenable to the present invention, through a sequence of radical addition and hydrogen atom transfer reactions. Specifically and without being bound to any particular theory, it is believed that compositions of the present invention involve radical-mediated C—H bond addition to C═C bonds.

It is further believed that direct hydrogen transfer from the saturated substrate presents challenges with respect to the rate of adduct radical trapping, given the relative strength of C—H bonds. In the present context, R—H addition of a tri-functional monomer builds hydrocarbon+monomer adducts to concentrations above their solubility limit. Reaction-induced phase separation gives a dispersed phase of concentrated adducts, whose C—H bond addition should generate crosslinked particles or fused microporous solids.

Free radicals can be produced for use in the present invention in a variety of ways known to persons skilled in the art. Suitable examples include peroxides, electron-beam, and gamma radiation. When a peroxide is used to generate free radicals, the peroxide is present in the reactive composition in an amount of about 0.005 weight percent to about 20.0 weight percent, preferably about 0.01 weight percent to about 10.0 weight percent, more preferably about 0.02 weight percent to about 10.0 weight percent, and most preferably about 0.3 weight percent to about 1.0 weight percent.

Suitable unsaturated coagents include allylic coagents having at least two allylic groups. Preferably, the unsaturated coagent is a triallylic coagent such as triallyl trimesate (TAM), triallyl phosphate (TAP), and their derivatives. Allylic coagents can be used to give a wider range of particle composition. Notably, TAM has been found to produce non-fusable particles of submicron diameters from a solvent-free, radical-initiated reaction with cyclooctane and other substrates.

Multi-functional allyl compound is needed to produce crosslinked microspheres; yet, cyclization of ortho-disposed allylic esters can limit the efficacy of a monomer such as diallyl phthalate (DAP). Also, it is noted that exo-cyclization is highly favored for smaller ring systems, but such selectivity is not observed for reactions that lead to rings comprised of seven or more members.

Tri-functional monomers are expected to provide the requisite balance of C—H bond addition and oligomerization without incurring complications due to cyclization. The monomer concentrations needed to produce microspheres favor oligomerization to give complex product mixtures.

The unsaturated coagent can be functionalized to introduce functionality to the particles. For example, functionality such as epoxide and alkoxysilane may be introduced. Additionally, the coagent can be polyfunctional.

The coagent is present in the reactive composition in an amount of about 0.5 weight percent to about 20.0 weight percent, preferably about 1.0 weight percent to about 10.0 weight percent, more preferably about 2.0 weight percent to about 10.0 weight percent, and most preferably about 3.0 weight percent to about 5.0 weight percent.

Suitable low molecular weight substrates include aliphatic hydrocarbons, ethers, esters, nitriles, amides, sulfides, amines, silicon containing materials (silicones), olefinic polymers, and their mixtures. Examples of suitable substrates are cyclooctane, polypropylene, cyclohexyl acetate, tetradecane, cyclohexane, and hexatriacontane. When the substrate is a propylene polymer, its molecular weight (Mn) is preferably less than 5000. As used herein, “low molecular weight” is defined as a molecular weight (Mn) less than about 5000.

Like the unsaturated coagent, the substrate may introduce functionality into the crosslinked organic particle. To that end, the substrate can be functionalized.

The substrate is present in the reactive composition in an amount of about 80 weight percent to about 99.5 weight percent, preferably about 90 weight percent to about 98 weight percent, and most preferably about 93 weight percent to about 97 weight percent.

The composition of crosslinked organic particles or fused microporous solids is dependent on the selected substrate. For example, when the substrate is cyclooctane, the crosslinked organic particle incorporates significant amounts of hydrocarbon. When the substrate is tetradecane, the crosslinked organic particles comprise predominately reacted coagent. It is noteworthy that even when the coagent is allylic and the substrate is not fully incorporated into the particles, the transformation of an allylic coagent into a crosslinked particle differs from conventional polymerization approaches. For instance, the resulting submicron, non-volatile particles can possess valuable properties.

While the present invention does not require solvents to facilitate particle formation, it is recognized that solvents may be useful in some embodiments of the present invention. However, solvent selection requires care. Solvent selection is limited to compounds that are less efficient hydrogen atom donors than the saturated substrate that is to be incorporated into the particle. Therefore, if aliphatic hydrocarbons such as cyclooctane are targeted, solvents should be restricted to non-alkylated aromatics, or avoided altogether.

Furthermore, the present invention contemplates the use of fillers. One suitable use of a filler is amorphous silica upon which crosslinked hydrocarbon can be deposited.

Additionally, the compositions of the present invention may incorporate flame retardant additives that contain phosphorous, halogens, and nitrogen. The flame-retardant particles of this invention would be suitable for a variety of applications, and could be applied by many ways such as spraying, dipping, and blending with various materials. Of particular interest are flame retardant powders (preferably halogen-free flame retardant powders) for use as fire extinguishers, and flame-retardant blends with polymers (preferably halogen-free) for wire and cable applications, building and construction, and automotive.

The present invention can be used as or in fillers, toners, surface-active fillers, reactive fillers, chromatography packing, and microfluidic devices.

In another embodiment, the present invention is a process for preparing a crosslinked polymer particle comprising (a) selecting a low molecular weight substrate from the group consisting of aliphatic hydrocarbon, ethers, esters, nitriles, amides, sulfides, amines, silicones, functionalized hydrocarbons, and olefinic polymers; (b) admixing an allylic coagent having at least two allylic groups; (c) admixing a free-radical inducing species to form a free-radical reactive mixture; (d) heating the mixture to a reaction temperature greater than the activation temperature of the free-radical inducing species for a time period greater than the half-life of the free-radical inducing species; and (e) cooling the mixture to precipitate the crosslinked polymer particles. Preferably, the reaction temperature is less than the temperature whereat the free-radical inducing species has a half-life less than 1 minute.

In yet another embodiment, it was noting that while mass spectrometry has taken the lead as an analytical tool in proteomic studies because of the sensitivity of the instrument and the ability to gather structural information, the complexity of some samples to be analyzed requires extensive purification before analysis. Borrowing from the drug development process [(a) Hopfgartner, G.; Bourgogne, E. Mass Spec. Rev. 2003, 22, 195-214. (b) Strege, M. A. J. Chromatogr. B 1999, 725, 67-78], research in high-throughput protein analysis has relied on mass spectrometry coupled with automated separation techniques such as nanoliquid chromatography (nanoLC-MS).

Liquid chromatography (LC) traditionally utilizes a separation column filled with tightly packed particles with diameters in the low micrometer range. The small particles provide a large surface area, which can be chemically modified and form a stationary phase. A liquid solvent or eluent, referred to as the mobile phase, is pumped through the column at an optimized flow rate that is based on the particle size and column dimensions. Analytes of a sample injected into the column flow through channels formed by the packed particles. The particles interact with the stationary phase relative to the mobile phase for different lengths of time, and, as a result, the analytes are eluted from the column separately at different times.

Capillary electrophoresis (CE) is a technique that utilizes the electrophoretic nature of molecules and/or the electroosmotic flow of liquids in small capillary tubes to separate analytes within a liquid sample. The capillary tubes are filled with buffer and a voltage is applied across it. It is generally used for separating ions, which move at different speeds when the voltage is applied depending on their size and charge.

Recently, rigid porous polymer monoliths (PPMs), which are highly crosslinked polymers that have a high porosity, have shown great potential as stationary phases for both LC and CE applications. The PPMs are generally used instead of particles in a column. The pores, which are inherent throughout the PPM, form channels through which sample may flow. Samples are loaded at one end of the column and eluted through the column via the channels with an eluting solvent. Different components of the sample may interact chemically with the PPM for different lengths of time relative to the eluting solvent, which results in the separation of some components. The separated components are eluted from the column at the other end of the column (the eluting end) at different times. The use of PPMs for these systems is attractive because of the ability to modify the physical properties of the stationary phase and the ease at which these monoliths can be prepared. One such property that can be varied is the pore size within the PPM, which has been shown to vary from 0.5-1.5 μM in diameter depending on the properties of the casting solvent.

The use of a PPM as a stationary phase has disadvantages from a chemical/physical standpoint including (i) the surface area of the PPM available to interact with components of a sample has been shown to be quite low and (ii) it is not amenable to being chemically modified.

The invention provides compositions, and processes and methods for making compositions, useful, for example, for separating sample for mass spectral analysis and/or acting as a stationary phase in chromatographic applications. Compositions according to the invention can comprise crosslinked polymer particles or crosslinked fused microporous solids, and polymeric material such that unoccluded channels are formed and the particles are able to interact with sample.

According to another embodiment of the present invention, the surface of at least one particle is suitable to interact with at least one component of a sample flowing through the channels.

The particles may optionally bear substituents that confer desirable chemical properties, e.g. affinity, to the particles so that the particles are suitable for chromatography.

The particles may be modified chemically and/or physically in order to be suitable for chromatography including reversed-phase chromatography, ion-exchange chromatography, size-exclusion chromatography, and affinity chromatography. The particles may be used without modification if they already have chemical and/or physical properties desirable for chromatography.

Different properties may be demonstrated by the same particles in different conditions, such as different solvent conditions.

It is also contemplated that particles useful for peptide synthesis and/or combinatorial synthesis are applicable to other embodiments of the invention. In this case, particles for peptide synthesis and/or combinatorial synthesis can be entrapped within a vessel, such as a column or capillary, so that flow-through synthesis can be performed. A variety of active species attached to the particles and/or part of the solution, such as nucleophilic amino acids or amino acids with activated esters. Alternatively or in addition, solutions could be passed through a catalytic bed for continuous synthesis applications. It will be understood that such a process can also be adapted for syntheses such as small molecule synthesis or polynucleotide synthesis.

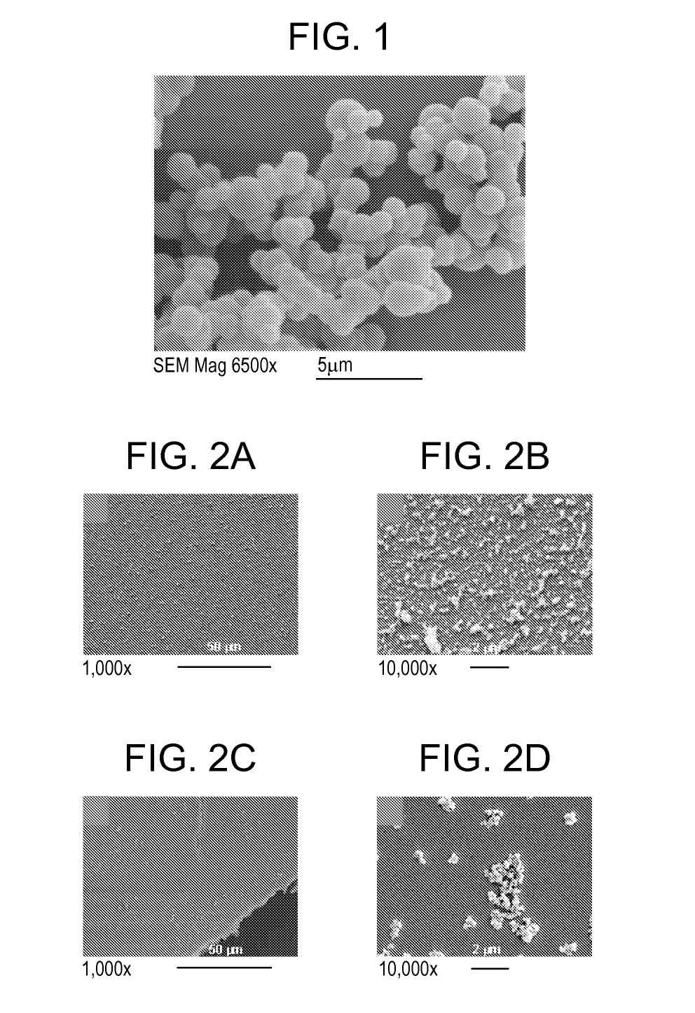

FIG. 1 is an image prepared by a scanning electron microscope of crosslinked polymer particles or fused microporous solids as the reaction products of cyclooctane and triallyl trimesate at 6500× magnification.

FIG. 2 is a collection of four images (a-d) prepared by a scanning electron microscope of crosslinked polymer particles or fused microporous solids as the reaction products of atactic polypropylene and triallyl trimesate, wherein (a) is as synthesized and measured at 1000× magnification, (b) is as synthesized and measured at 10,000× magnification, (c) is pressed at 200 degrees Celsius and measured at 10,000× magnification, and (d) is pressed and dispersed and measured at 10,000× magnification.

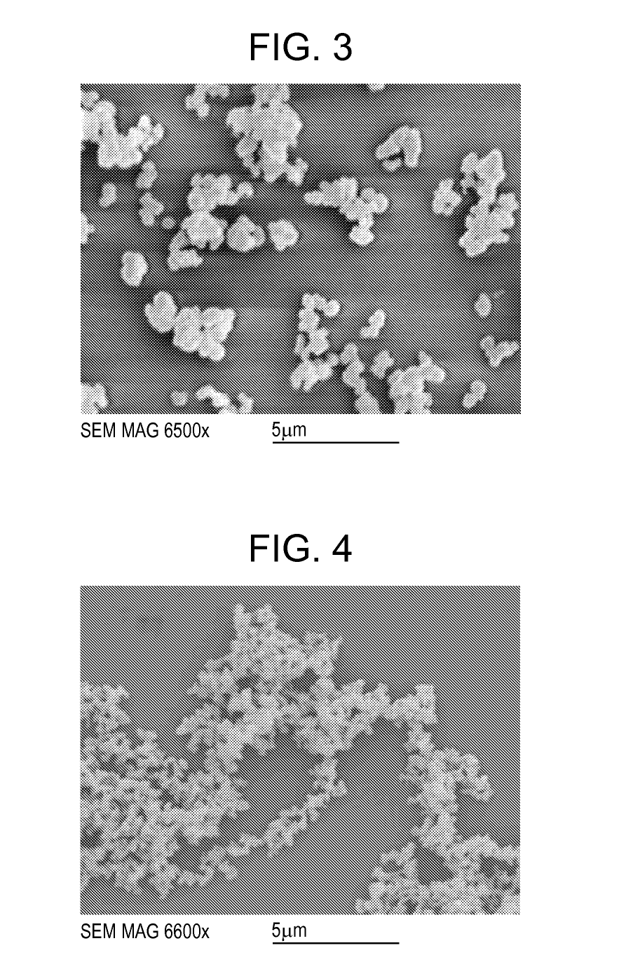

FIG. 3 is an image prepared by a scanning electron microscope of crosslinked polymer particles or fused microporous solids as the reaction products of tetradecane and triallyl trimesate at 6600× magnification.

FIG. 4 is an image prepared by a scanning electron microscope of crosslinked polymer particles or fused microporous solids as the reaction products of tetradecane and triallyl phosphate at 6600× magnification.

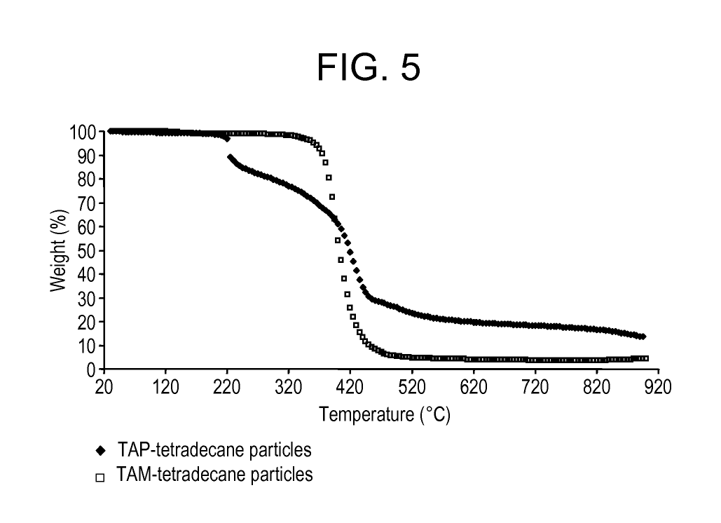

FIG. 5 is a graph of Thermal Gravimetric Analysis (TGA) for (a) crosslinked polymer particles or fused microporous solids as the reaction products of tetradecane and triallyl trimesate and (b) crosslinked polymer particles or fused microporous solids as the reaction products of tetradecane and triallyl phosphate.

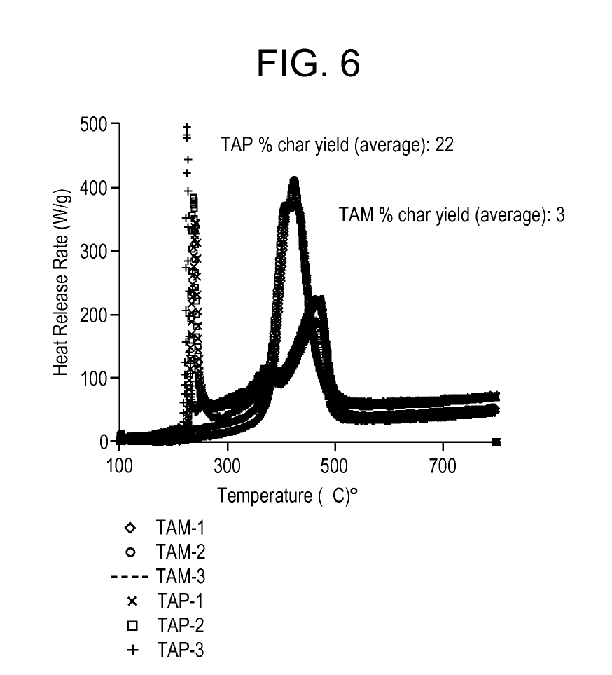

FIG. 6 is a graph Pyrolysis Combustion Flow Calorimetry (PCFC) (a) crosslinked polymer particles or fused microporous solids as the reaction products of tetradecane and triallyl trimesate and (b) crosslinked polymer particles or fused microporous solids as the reaction products of tetradecane and triallyl phosphate.

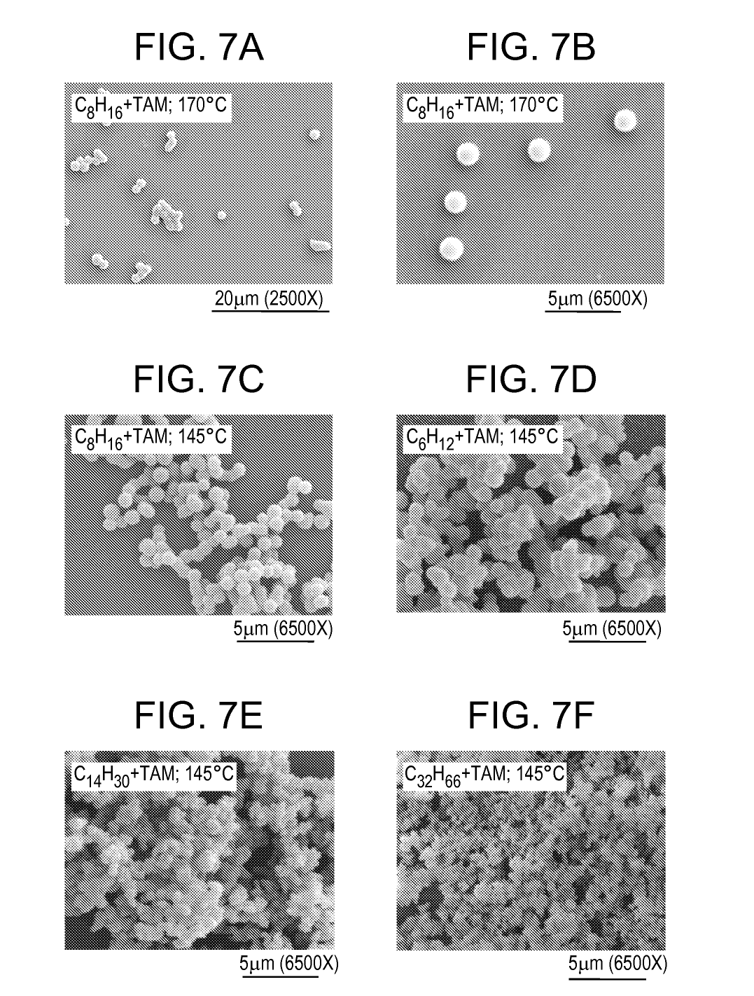

FIG. 7 is a collection of six images (a-g) prepared by a scanning electron microscope of (a) particulate matter prepared from 56:1 molar ratio of cyclooctane and triallyl trimesate at a reaction temperature of 170 degrees Celsius at 2500× magnification, (b) particulate matter prepared from 56:1 molar ratio of cyclooctane and triallyl trimesate at a reaction temperature of 170 degrees Celsius at 6500× magnification, (c) crosslinked polymer particles or fused microporous solids as the reaction products of cyclooctane and triallyl trimesate prepared at 145 degrees Celsius in the presence of 37 μmole/g of dicumyl peroxide and measured at 6500× magnification, (d) crosslinked polymer particles or fused microporous solids as the reaction products of cyclohexane and triallyl trimesate prepared at 145 degrees Celsius and measured at 6500× magnification, (e) crosslinked polymer particles or fused microporous solids as the reaction products of tetradecane and triallyl trimesate prepared at 145 degrees Celsius and measured at 6500× magnification, and (f) crosslinked polymer particles or fused microporous solids as the reaction products of hexatriacontane and triallyl trimesate prepared at 145 degrees Celsius and measured at 6500× magnification.

### EXAMPLES

The following non-limiting examples illustrate the invention.

Semi-preparative fractionation of model compounds was accomplished by high pressure liquid chromatography (HPLC) with a Waters Model 400 instrument equipped with a normal-phase Supelcosil PLC-Si column and differential refractive index as well as UV-Vis detectors. NMR spectra were recorded with a Bruker AM-600 spectrometer in CDCl₃, with chemical shifts reported relative to tetramethylsilane. High resolution mass spectra were recorded on an Applied Biosystems/MDS Sciex QSTAR XL QqTOF mass spectrometer with electrospray ionization. Analyses of cumyl alcohol and acetophenone were conducted with a Hewlett Packard 5890 series II gas chromatograph equipped with a Supelco SPB-1 microbore column using 2 mL/min of helium as carrier gas.

X-ray diffraction analysis was conducted using a Scintag XDS 2000 diffractometer (Cu Kα radiation λ=1.5406 Å, generator voltage=45 kV, current=40 mA). Differential scanning calorimetry (DSC) measurements were acquired with a DSCQ100 calorimeter from TA Instruments using a heating rate of 10 degrees Celsius per minute. Scanning electron microscopy analysis of gold-sputtered samples was performed using a JEOL JSM-840 instrument.

Abstraction efficiency. A solution of DCP (0.02 g) in cyclooctane was placed in a 10 mL stainless steel vessel and deoxygenated by pressurizing with high purity nitrogen to 200 psi, mixing and releasing for a total of 3 cycles. The vessel was then placed in an oil bath at 170 degrees Celsius under constant magnetic stirring for 30 minutes, and cooled to room temperature before analyzing for cumyl alcohol and acetophenone content by gas chromatography.

### Example 1

### Crosslinked Particles from Cyclooctane (CyOc)/Triallyl Trimesate (TAM)

Cyclooctane (CyOc, 99%, Sigma-Aldrich, Oakville, ON, Canada), triallyl trimesate (TAM, 99%, Monomer-Polymer & Dajac Labs, Feasterville-Trevose, Pa., USA), and dicumyl peroxide (DCP, 98%, Sigma-Aldrich) were used as received.

Cyclooctane (3 g, 26 mmole), TAM (0.18 g), and DCP (0.012 g) were heated to 170 degrees Celsius for 20 minutes. The mixture was cooled to room temperature, filtered, and washed with toluene before drying under vacuum. This material was dispersed by sonication in acetone at room temperature, deposited on a glass slide, and sputtered with gold. Analysis with a JEOL JSM-840 scanning electron microscope produced the image provided in FIG. 1. The elemental composition of these particles was 69.32 weight percent carbon, 7.66 weight percent hydrogen and 23.63 weight percent oxygen, which is consistent with a TAM content of 77%.

### Comparative Example of TAM Activation without Substrate

Reagent details are provided in Example 1. TAM (0.2340 g) and DCP (0.72 mg, 0.31 weight percent) were heated to 170 degrees Celsius for 15 minutes, giving a glassy, bulk solid with an elemental composition of 65.72 weight percent carbon, 5.60 weight percent hydrogen and 27.80 weight percent oxygen, which is consistent with a TAM content of 96%.

### Example 2

### Crosslinked Particles from Atactic-Polypropylene (a-PP)/Triallyl Trimesate (TAM)

Atactic polypropylene (a-PP, Mn=3,800, Scientific Polymer Products Inc., Ontario, N.Y., USA) was hydrogenated prior to use by treatment of a hexanes solution with platinum supported on carbon at 20 bar H₂ gas, 100 degrees Celsius for 50 hours, after which the polymer was recovered by precipitation from acetone and dried under vacuum. Details of all other reagents are provided in Example 1.

A-PP (2 g) and TAM (0.1 g, 5 weight percent) were degassed by three cycles of vacuum evacuation and N₂ atmosphere replacement. The mixture was immersed in an oil bath at 170 degrees Celsius and stirred for 1 min to ensure homogeneity, after which DCP (0.006 g, 0.3 weight percent) was introduced and left to decompose for 15 minutes, yielding a grafted product of a-PP and TAM (i.e., a-PP-g-TAM, where g means “grafted”). This product was fractionated by extracting two grams of material with THF (20 ml) at 25 degrees Celsius for 3 hours, yielding a cloudy solution. Left to stand for 24 hours, the mixture separated into a clear solution and a solid residue. The clear solution was decanted from the solids, from which a lightly-branched fraction (1.84 g) was precipitated from acetone (80 ml) and dried under vacuum. The THF extraction residue was washed twice with THF (10 ml) and dried under vacuum to isolate a hyper-branched fraction (0.25 g). This hyper-branched fraction was extracted from a Soxhlet thimble with refluxing toluene for 2 hours. The toluene soluble extract was precipitated into excess acetone and dried under vacuum to give hyper-branched a-PP-g-TAM (0.23 g).

The toluene extraction residue was dried under vacuum to give the isolable particle fraction (0.02 g). This material was dispersed by sonication in acetone at room temperature, deposited on a glass slide, and sputtered with gold.

Scanning Electron Microscopy (SEM) analysis produced the images that are provided in FIG. 2. Images recorded at 1,000× and 10,000× magnification revealed primary particles with submicron dimensions from which larger aggregated structures were constructed (FIGS. 2a, b). Pressing these particles at 200 degrees Celsius for 5 minutes produced an opaque, white solid (FIG. 2c), which disintegrated upon sonication in THF into dispersed primary particles (FIG. 2d). These particles had an elemental composition of 69.71 weight percent carbon, 7.87 weight percent hydrogen and 20.92 weight percent oxygen, which is consistent with a TAM content of 78 weight percent.

### Example 3

### Crosslinked Particles from Tetradecane/Triallyl Trimesate (TAM)

Tetradecane was used as received from Sigma-Aldrich. Details of all other reagents are provided in Example 1.

Tetradecane (150 g), TAM (7.5 g, 6 weight percent) and DCP (0.9 g, 0.6 weight percent) were sealed within a glass pressure tube equipped with a magnetic stir bar and immersed in an oil bath at 170 degrees Celsius for 25 minutes, yielding tetradecane-g-TAM. The mixture was cooled to room temperature, filtered and the solids washed with toluene before drying under vacuum. These solids were dispersed by sonication in acetone, deposited on a glass slide and analyzed by SEM to give the image provided in FIG. 3. Elemental analysis of this material revealed a composition of 67.68 weight percent carbon, 6.80 weight percent hydrogen and 24.13 weight percent oxygen, which is consistent a TAM content of 85 weight percent.

### Example 4

### Crosslinked Particles from Tetradecane/Triallyl Phosphate (TAP)

Triallyl phosphate was used as received from TCI. Details of all other reagents are provided in Example 3.

Tetradecane (150 g), TAP (7.5 g, 6 weight percent), and DCP (0.9 g, 0.6 weight percent) were sealed within a glass pressure tube equipped with a magnetic stir bar and immersed in an oil bath at 170 degrees Celsius for 20 minutes, yielding tetradecane-g-TAP. Solid products were isolated as described in Example 4, and analyzed by SEM to give the image presented in FIG. 4. Elemental analysis of the solids revealed a composition of 52.38 weight percent carbon, 7.75 weight percent hydrogen and 12.14 weight percent phosphorus, which is consistent with a TAP content of 90 weight percent.

### Thermal Stability of Crosslinked Particles of Examples 3 and 4

The thermal stability of the crosslinked particles of Examples 3 and 4 was investigated by Thermal Gravimetric Analysis (TGA) and Pyrolysis Combustion Flow Calorimetry (PCFC). TGA testing was done using TA Instruments Model Q5000 version 2.4, and PCFC testing was done using a Micro Combustion Calorimeter Model Govmark MCC-1. The TGA testing was conducted under nitrogen by raising the temperature from 30 degrees Celsius to 900 degrees Celsius at a rate of 10 degrees Celsius per minute. Pyrolysis Combustion Flow Calorimetry (PCFC) was conducted on 1.3 mg samples by heating in the pyrolyzer under nitrogen from 90 degrees Celsius to 800 degrees Celsius at a rate of 1 degree Celsius per second, with the combustor operating at 900 degrees Celsius with oxygen flow rate of 20 cm³/min and nitrogen flow rate of 80 cm³/min. TGA testing was done on each composition to determine the weight loss as a function of temperature, while PCFC testing was done to determine the specific heat release rates as functions of temperature.

The results of TGA analyses are presented in FIG. 5. The TAM-tetradecane particles were stable to about 350 degrees Celsius, after which there was rapid weight loss. In contrast, the TAP-tetradecane particles began losing weight around 220 degrees Celsius, but the weight loss was subsequently arrested such that the weight loss curves of the two particles crossed over at 395 degrees Celsius, after which the weight loss was considerably slower with TAP-tetradecane particles. The final amount of residue (char) was relatively higher with the phosphorous-containing particles. The improved thermal stability of the higher temperature weight loss component in TGA under nitrogen is often indicative of improved flame retardancy, since decomposition of a burning polymer to produce fuel that feeds the flame is known to occur under similar conditions (pyrolysis in an oxygen deficient environment).

The results of PCFC analyses are given in FIG. 6. The terms “TAM-1 . . . TAP-3” refer to replicates of either TAM derived particles or TAP derived particles. The peak heat release rate with TAM-tetradecane particles occurred around 430 degrees Celsius. In contrast, the peak heat release rates with TAP-tetradecane particles were evident at substantially lower temperatures (around 230 degrees Celsius), and the char yield (average of 3 values per sample) was considerably greater with the phosphorous containing particles. These results were consistent with the trends observed from TGA testing. In particular, the PCFC results for TAP show that the initial decomposition leading to the first peak results in formation of a stable structure, as evidenced by a movement of the second peak to higher temperature when compared to the non-TAP materials. This improved stability of the higher temperature component is expected to result in improved fire retardant performance.

### Preparation of Components for Comparative Examples 5-7 and Examples 8-14

Cyclooctane (3 g, 26 mmole) and the desired amounts of triallyl trimesate (0.03 g-0.15 g, 0.09 mmole-0.45 mmole) and dicumyl peroxide (0.003 g-0.015 g, 0.011 mmole-0.055 mmole) were sealed in a glass pressure tube and heated in an oil bath to the desired reaction temperature (170 degrees Celsius, 145 degrees Celsius) under continuous agitation by a magnetic stir bar. After five initiator half-lives, the tube was cooled to room temperature and a small amount of xylenes was added to produce a clear solution above insoluble, crosslinked solids. The liquid fraction was analyzed for residual TAM content by gas chromatography. An aliquot of this liquid was treated by Kugelrohr distillation to remove residual cyclooctane, and analyzed for residual allyl and grafted hydrocarbon content by ¹H-NMR spectroscopy.

Solid reaction products were washed with hexanes, dried under vacuum and weighed to determine overall mass-based yields. Solids composition was determined by elemental analysis for carbon, hydrogen and oxygen content to give the relative proportions of cyclooctane and TAM. Further analyses included scanning electron microscopy of gold-coated samples, powder X-ray diffraction, and differential scanning calorimetry.

### Comparative Examples 5-7 and Examples 8-10

As the following Table I indicates, dilute solutions of TAM in cyclooctane did not produce a crosslinked solid phase, as a 100:1 C₈H₁₆:TAM solution remained clear while 7.4 μmole/g of DCP was decomposed at 170 degrees Celsius. It did, however, become cloudy on cooling to room temperature to give a cyclooctane-rich solution, and an oil comprised of cyclooctane+TAM adducts. Adding xylenes re-established a homogeneous condition, leaving no solid or oil residue behind. Of the TAM charged to the reaction, 24% was unreacted, with the remaining 76% of converted monomer having an average of 1.7 mol cyclooctane and 1.0 mol of allyl functionality per mol of aromatic ester (Comparative Example 5).

Two reactions conducted with a 56:1 C₈H₁₆:TAM ratio reveal the influence of monomer loading (Comparative Examples 6 and 7). These solutions were initially clear when heated to 170 degrees Celsius, but became hazy within the first half-life of the peroxide. Solids became visible shortly thereafter, and a considerable volume of precipitate was observed on reaction vessel surfaces after complete initiator decomposition. Cooling to room temperature led to further phase separation, as TAM-derived products became insoluble in the predominately hydrocarbon medium. Taking the mixture up in xylenes fractionated the mixture into soluble adducts and crosslinked solids, the yields and composition of which are listed in Table I.

Irrespective of peroxide loading, 56:1 C₈H₁₆:TAM reactions carried out at 170 degrees Celsius gave high yields of xylene-soluble compounds whose composition did not differ significantly from those generated from more dilute solutions. The crosslinked precipitate phase was relatively lean in hydrocarbon, with elemental analysis revealing on the order of 0.5 mol of C₈H₁₆ per mol TAM. This composition suggests that oligomerization contributes significantly to reaction-induced phase separation, with TAM+C₈H₁₆ adducts engaging TAM to produce insoluble material.

Powder x-ray diffraction analysis of the crosslinked solids gave a broad halo that is characteristic of amorphous solids while differential scanning calorimetry showed no evidence of a significant phase transition from −25 degrees Celsius to 200 degrees Celsius. FIG. 7a, b contains scanning electron microscopy (SEM) images for solids prepared for Comparative Example 7. These images reveal primary particles with sizes on the order of 1-2 μm in various states of aggregation, with a relatively small population of single spheres. Once formed, aggregates could not be affected by pressing the product at 200 degrees Celsius or by sonicating the material in organic solvents.

Reactions of 56:1 C₈H₁₆:TAM solutions at 145 degrees Celsius converted 18% to 23% of TAM to crosslinked solids, depending on peroxide loading (Examples 8 to 10). Furthermore, these precipitates contained 0.8 mol C₈H₁₆ per mol TAM, as opposed to the 0.5:1.0 maximum generated at 170 degrees Celsius. The higher hydrocarbon content of the precipitated solids, and the depletion of xylene-soluble material, is consistent with a lower solubility of TAM adducts/oligomers.

Based on the SEM image of solids produced at 145 degrees Celsius (FIG. 7c; Example 9), temperature had a marginal effect on the size of cyclooctane-derived particles. Solids generated under these conditions were comprised of primary particles with sizes on the order of 1-2 μm—comparable to those generated at 170 degrees Celsius. However, aggregation was extensive at this higher solids yield and single particles could not be found amongst reaction products.

TABLE I

| | | | | | Xylene-Soluble Products | | | Insoluble Solid Products | | |
|---|---|---|---|---|---|---|---|---|---|---|
| | C₈H₁₆:TAM | [DCP] | Temp | TAM | TAM | C₈H₁₆:TAM | Allyl:TAM | TAM | Overall | C₈H₁₆:TAM |
| Example | Molar Ratio | μmole/g | ° C. | Conversion % | Yield^{a} mole % | Molar Ratio | Molar Ratio | Yield^{a} % | Yield^{b} wt % | Molar ratio |
| 5 | 100:1 | 7.4 | 170 | 76 | 100 | 1.7:1 | 1.0:1 | 0 | 0 | — |
| 6 | 56:1 | 7.4 | 170 | 73 | 99+ | 1.5:1 | 0.9:1 | <1 | trace | 0.4:1 |
| 7 | 56:1 | 14.8 | 170 | 88 | 99+ | 1.9:1 | 0.6:1 | <1 | trace | 0.5:1 |
| 8 | 56:1 | 14.8 | 145 | >99 | 69 | 1.7:1 | 0.5:1 | 23 | 1.5 | 0.8:1 |
| 9 | 56:1 | 37.0 | 145 | >99 | 74 | 1.9:1 | 0.4:1 | 19 | 1.2 | 0.8:1 |
| 10 | 56:1 | 74.0 | 145 | >99 | 76 | 2.5:1 | 0.3:1 | 18 | 1.1 | 0.8:1 |

^{a}Mole percent of converted TAM in this product
^{b}Weight percent of total C₈H₁₆ + TAM mixture in crosslinked solids

### Examples 11-14

Because C—H bond addition to TAM is intended to generate adducts that comprise crosslinked particles, the molar mass of the hydrocarbon will affect overall mass-based reaction yields and the solid phase's crosslink density. Table II summarizes particle formation experiments with a range of hydrocarbons. Three key differences were observed upon shifting from cyclooctane to other hydrocarbons. The overall particle yield increased, the amount of TAM converted to crosslinked solids increased, as did the molar ratio of monomer to hydrocarbon within the solid fraction.

TABLE II^{a}

| | | Overall | TAM | RH:TAM |
|---|---|---|---|---|
| Example | Hydrocarbon | Yield^{b} wt % | Yield^{c} % | Molar Ratio |
| 11 | Cyclooctane | 1.2 | 19 | 0.8:1 |
| 12 | Cyclohexane | 2.9 | 54 | 0.3:1 |
| 13 | Tetradecane | 3.2 | 55 | 0.3:1 |
| 14 | Hexatriacontane | 4.1 | 66 | 0.2:1 |

^{a}37 μmole/g DCP; 0.15 mmole TAM/g solution; 145 degrees Celsius
^{b}Weight percent of total RH + TAM mixture recovered as insoluble solids.
^{c}Mole percent of TAM recovered in insoluble solids.

Given the importance of hydrogen transfer to graft initiation and propagation, cyclooctane affords higher R—H addition yields and simpler grafting products than other hydrocarbons. In the present context, the lower reactivity of cyclohexane, tetradecane and hexatriacontane resulted in particles that were leaner in hydrocarbon than the corresponding cyclooctane-derived materials.

The SEM images provided in FIGS. 7 d, e, and f reveal a progressive decline in primary particle size on moving from cyclohexane to tetradecane and further to hexatriacontane. The latter produced coalesced solids with primary particles on the nanometer scale.

We claim:

1. A crosslinked copolymer particle comprising:
free-radical reactively polymerized product of
(a) a low molecular weight substrate,
(b) an allylic coagent having at least two allylic groups, and
(c) a free-radical inducing species.

2. The crosslinked copolymer of claim 1 wherein the low molecular weight substrate is selected from the group consisting of aliphatic hydrocarbon, ethers, esters, nitriles, amides, sulfides, amines, silicones, functionalized hydrocarbons, and olefinic polymers.

3. The crosslinked copolymer of claim 2 wherein the low molecular weight substrate is selected from the group consisting of cyclooctane, cyclohexane, tetradecane, and hexatriacontane.

4. The crosslinked copolymer of claim 1 wherein the allylic coagent is a tri-functional monomer.

5. The crosslinked copolymer of claim 3 wherein the tri-functional monomer is selected from the group consisting of triallyl trimesate, triallyl phosphate, and derivatives thereof.

6. A process for preparing a crosslinked polymer particle comprising
(a) selecting a low molecular weight substrate from the group consisting of aliphatic hydrocarbon, ethers, esters, nitriles, amides, sulfides, amines, silicones, functionalized hydrocarbons, and olefinic polymers;
(b) admixing an allylic coagent having at least two allylic groups;
(c) admixing a free-radical inducing species to form a free-radical reactive mixture;
(d) heating the mixture to a reaction temperature greater than the activation temperature of the free-radical inducing species for a time period greater than the half-life of the free-radical inducing species; and
(e) cooling the mixture to precipitate the crosslinked polymer particles.

7. The process of claim 6 wherein the reaction temperature is less than the temperature whereat the free-radical inducing species has a half-life less than 1 minute.
